(19) United States
(12) Patent Application Publication
(10) Pub. No.: US 2007/0206760 A1
(43) Pub. Date: Sep. 6, 2007

(54) Service-initiated voice chat

(76) Inventors: Jagadish Bandhole, Saratoga, CA (US); T.K. Lakshman, San Carlos, CA (US); Sekaran Nanja, San Jose, CA (US); Victor Ho, Foster City, CA (US)

Correspondence Address: Fonemine c/o Murabito, Hao & Barnes LLP, Two North Market Street, 3rd Floor, San Jose, CA, 95113, US

(21) Appl. No.: 11/644,766

(22) Filed: Dec. 22, 2006

Related U.S. Application Data
(60) Provisional application No. 60/771,724, filed on Feb. 8, 2006.

(51) Int. Cl. H04M 3/42

(52) U.S. Cl. 379/202.01

(57) ABSTRACT

Disclosed herein is technology for, among other things, initiating a voice chat. The technology includes accepting information identifying one or more individuals to invite to participate in the voice chat, initiating calls to the one or more individuals to invite the individuals to join the voice chat, and establishing the voice chat amongst all individuals who accept their respective invitations to join in the voice chat with voice advertisements and chat control supported within the voice chat.

### CROSS-REFERENCE TO RELATED APPLICATIONS

The present application is related to U.S. Provisional Patent Application No. 60/742,705, entitled “Digital Personal Assistant And Automated Response System,” filed Dec. 5, 2005 which has a corresponding U.S. Utility patent application Ser. No.______, entitled the same, filed Dec. 4, 2006; U.S. Provisional Patent Application No. 60/771,724, entitled “Telephony Based Publishing, Search, Alerts And Notifications, Collaboration, And Commerce Methods,” filed Feb. 8, 2006; and U.S. Provisional Patent Application No. 60/732,792, entitled “Platform For Telephone-Optimized Data and Voce Services,” filed Nov. 1, 2006 which has a corresponding U.S. Utility patent application No.______, entitled the same, filed Nov. 1, 2006, which applications are incorporated herein by reference in their entirety and for all purposes.

### BACKGROUND

Presently, telephone calls are typically initiated by a caller dialing a number at one handset, which then causes the callee's handset to ring. Once a call been initiated, only a few outcomes are possible: the callee answers, the line is busy, there is no answer, the call is answered by an automated voicemail system or an answering machine, etc. If the call is not answered by the callee, the caller's options are either to leave a message (if possible) or call back repeatedly until the callee answers. Some call services also allow for a caller, upon getting a busy tone, to press certain keys (e.g.,*9), which will then automatically call the callee for the caller when the callee's line is no longer busy.

In addition, if one person wishes to call another at a designated time, he or she must actively remind him or herself (i.e., make an entry in a calendar, set an alarm clock, set a call reminder on a cell phone, etc.) to make a call at the intended time. Naturally, even with these reminders, it is possible to forget to make the call.

Over the past few decades, advances in technology have also allowed for the initiation of 3-way calls. In order to initiate a 3-way call, a caller typically dials the number of a first callee, establishes a connection with the first callee, puts the first callee on hold, dials the number of a second callee, establishes a connection with the second callee, and thereafter patches the two calls together in a conference. As in the above one-way call, similar outcomes are possible with respect to each callee. It should therefore be appreciated that problems establishing the intended phone call are compounded with respect to 3-way calling. Thus, the initiating party (i.e., originator) may get a first callee on the line only to find out that the second callee is unavailable, causing both parties valuable time. Moreover, as before, if the originator intends to have the 3-way call at a designated time, it is the originator's responsibility to remember to initiate a call at that time.

In a case of a conference call involving more than three parties, a call-in number is typically used. For example, one person will typically provide the other participants with a call-in telephone number and an access code. At a designated time, each participant dials the call-in number and enters the access code. The participants are then patched together in an N-way conference call one. In this scenario, each participant is individually responsible for his or her joining of the conference call (i.e., the conference call is 100% “pull”). If one or more of the participants forgets, the call may be in vain because a necessary party may be missing or a quorum of participants is not present.

There are additional problems with the call-in number system of conference calling. For example, the initial invitation to participate in the call (e.g., an e-mail containing the call-in information) may be freely forwarded by any the recipients to other individuals. Thus, the originator does not have complete control over who may join the conference. Moreover, there is no reliable way of determining whether there is a “silent participant” on the call.

Furthermore, conference calling is typically available only to businesses, and not available for use by any consumer. Consequently, consumers have to set up conference calls via out-of-band mechanisms such as web access or email (not directly via the phone). This diminishes the impulse inclination of any consumer to initiate an N-way “chat” directly from their phone.

Moreover, to initiate a 2-way or 3-way call every consumer needs to know the telephone number of every other participant. Consumers may not be willing to share their telephone number because, once it is shared, anyone who has access to the telephone number can call them any time.

Another scenario is often used to establish 1:N (N-way) communications: the originator calls the first participant and speaks to her/him, then hangs up and subsequently calls other participants in order. Typically the same information is conveyed to each participant, thus creating an onerous and arduous burden on the originator. Ideally, the originator would like to record the message to be sent, and then just delegate the onerous task of calling each recipient and playing back the message to an assistant or administrator. An example could be a sales manager out on the field who wishes to inform each of his/her sales reps of the same task. Currently there is no mechanism to achieve this 1:N (N-way) communications

Clearly then, conventional methods of the initiating phone calls (both one-way and conference calls) are inefficient. In the case of conference calls, the conventional methods are highly dependent on the reliability of each participant. Thus, human error also becomes a factor. For businesses that often engage in conference calls, valuable time can be wasted if attempts at initiating conference calls are unsuccessful for a variety of reasons including the unavailability or forgetfulness of participants.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Disclosed herein is technology for, among other things, initiating a voice chat. The technology includes accepting information identifying one or more individuals to invite to participate in the voice chat, initiating calls to the one or more individuals to invite the individuals to join the voice chat, and establishing the voice chat amongst all individuals who accept their respective invitations to join in the voice chat.

Thus, embodiments provide technology for service-initiated phone calls. As stated above, the calls are not necessarily limited to conference calls. Because the calls are service-initiated, rather than originator-initiated, a layer of anonymity can be provided for the originator and that the originator's phone number is not known to the other invitees. Moreover, the originator has complete control over who the participants are, because the originator specifies them in the beginning and only those individuals specified are called. The service guarantees that only the participants selected by the originator (and no one else) is called, and indicates exactly who accepted the invitation for the voice chat and is currently on the call.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIGS. 1A-1C illustrate a flowchart 100 for a process of initiating a voice chat, in accordance with various embodiments of the present invention.

FIG. 2 illustrates a block diagram of a system 200 for initiating a voice chat, in accordance with various embodiments the present invention.

FIG. 3 shows a flow diagram of one embodiment of the present invention for initiating a multi-party teleconference.

FIG. 4 shows a detailed diagram for a teleconferencing system whereby the call manager calls the designated participants and invites them to join the teleconference.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

Generally speaking, embodiments provide technology for service-initiated voice chats among any number of individuals. In one embodiment, the voice chat may only involve a single individual, for example, to serve as a reminder, wake-up call, etc wherein a voice message (be it automatically generated or pre-recorded) is played back to the single participant who can then take control actions upon hearing the voice. The voice chat may also be a more traditional 2-way chat, a 3-way conference call, or an N-way conference call with any other number of individuals. The service receives information identifying those individuals to be invited to the voice chat, calls/invites those individuals based on the information provided, and establishes the voice chat among those individuals that accept their invitations.

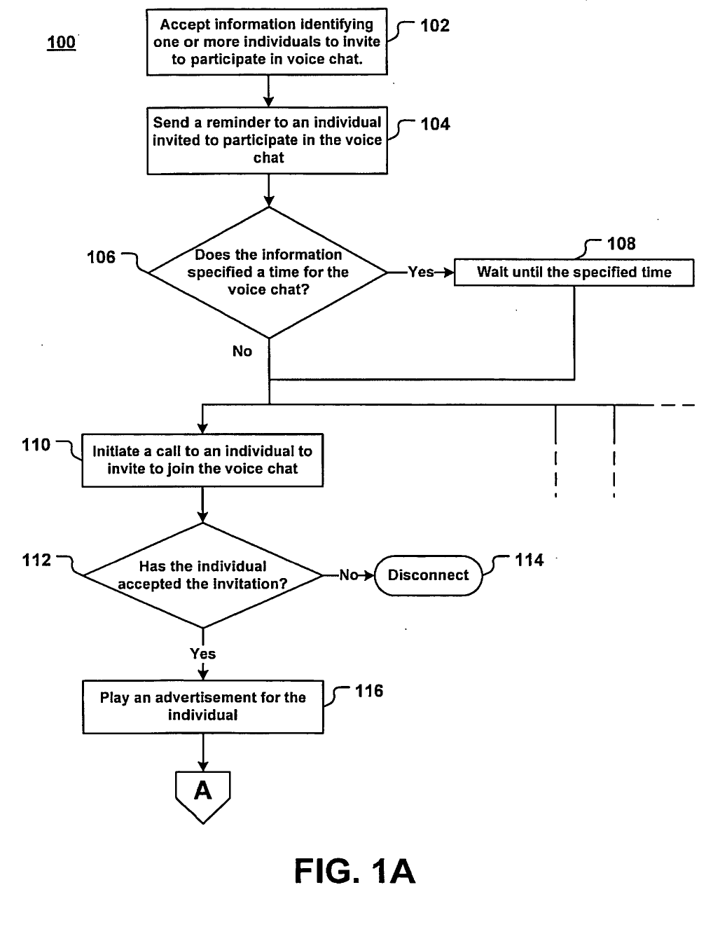

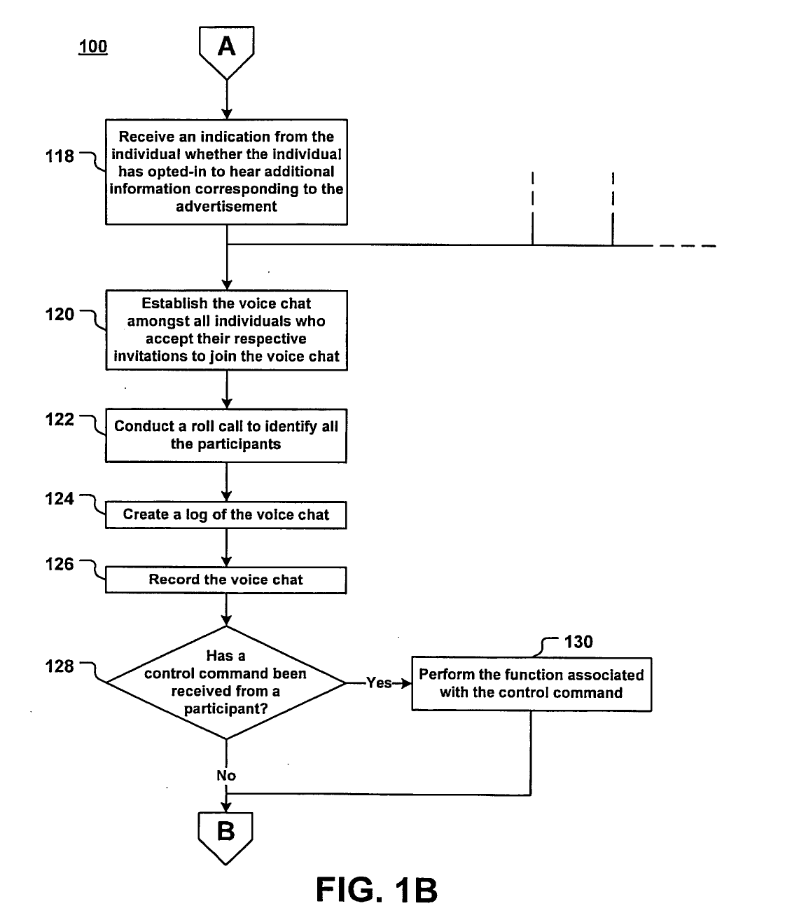

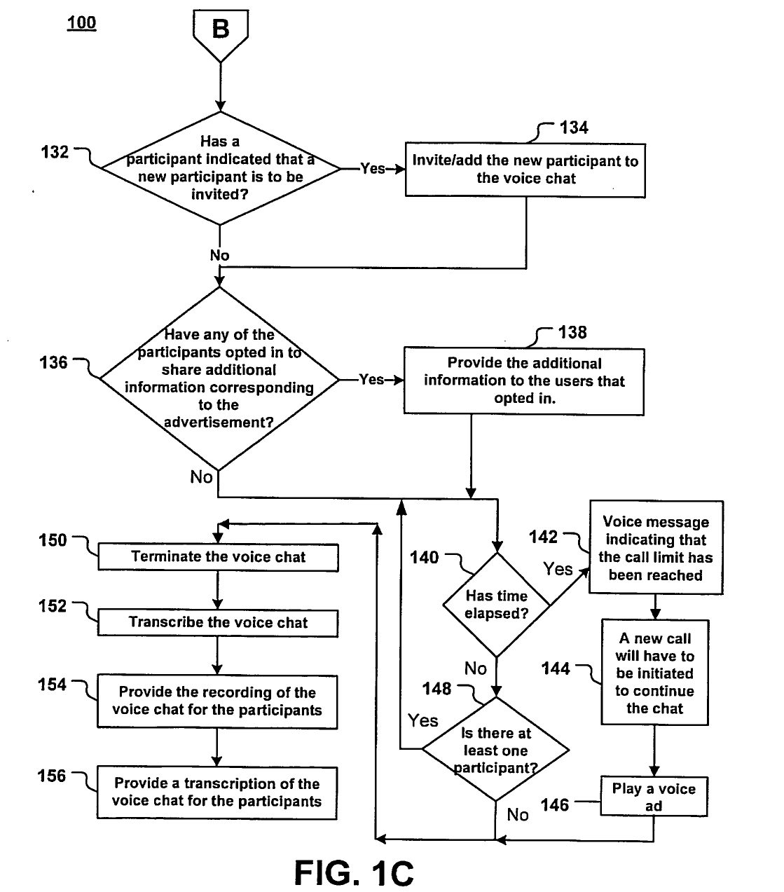

FIGS. 1A-1C illustrate a flowchart 100 for a process of initiating a voice chat, in accordance with various embodiments of the present invention. Although specific operations are disclosed in flowchart 100, such operations are exemplary. Flowchart 100 may not include all of the operations illustrated by FIGS. 1A-1C. Also, flowchart 100 may include various other operations and/or variations of the operations shown by FIGS. 1A-1C. Likewise, the sequence of the operations of flowchart 100 can be modified.

In one embodiment, flowchart 100 begins at block 102 where information is accepted that identifies one or more individuals to invite to participate in a voice chat. This information may be received in a number of different ways. For example, the information may be included in a text message sent via a mobile telephone. The information may be included within an email message. The information may also be submitted via a voice call or submitted via a web page. In one embodiment, the web page is accessible via a mobile telephone. Moreover, the information identifying the individuals may take on a number of different forms. For example, with respect to a particular individual, the information may simply include the individual's phone number (landline, cellular, or otherwise). The phone number can be any telephone number worldwide. In another embodiment, the information includes an alias unique to the individual that effectively screens the organizer from knowing the individual's actual phone number as well as screening the participant from knowing the originator's phone number. Such an alias may be hosted by a service. The service may also provide additional features, such as allowing the owner of the alias to create rules blocking all or some calls from everyone or from specific originators.

In one embodiment, voice chats can be scheduled for a specific date and time in the future. In such a case, it may be desirable to send a notification and/or a reminder to the invitees notifying them of the scheduled voice chat (block 104). Once again the notification and reminder message may be sent via SMS text message, email, voice call reminder, etc. The notification/reminder may also include, but is not limited to, information such as the purpose of the call, the names of the invitees, links to other relevant items, and personalized advertisements. In one embodiment, the service determines if the information provided specifies a time for the voice chat (block 106). If yes, then the service waits until the specified time to initiate the voice chat (block 108). If not, the service begins to initiate the voice chat immediately.

In addition to specifying a time, the organizer of the voice chat may also specify several other control settings. For example, the organizer may choose to set a quorum for the voice chat. For example, the originator may specify that the voice chat will not be established if less than X individuals accept their invitation. Similarly, the organizer may designate one or more of the individuals as “necessary parties,” such that the voice chat will not be established in the absence of the necessary parties. The organizer may also define a course of action in response to a busy signal, no answer, or voicemail, for example.

At this point in FIG. 1A, flowchart 100 begins to initiate the voice chat among the invited individuals. For simplicity, blocks 110-118 shall be described with respect to a single individual. However, it should be appreciated that the initiation with respect to each individual may be conducted either serially or in parallel. At block 110, a call is initiated (by a server, for example) to an individual to invite the individual to join the voice chat. The individual who receives a telephone call sees one of two caller phone numbers on his/her phone device: (a) the originator phone number (if the originator indicated that his/her phone number be published to all the participants so they know who is calling them) or (b) a service number (if the originator indicated that his/her phone number should be hidden from participants). It is then determined whether the individual has accepted the invitation (block 112). If not, the service disconnects (block 114). Assuming the individual accepts the invitation, in one embodiment, an advertisement is played for the individual (block 116). In other words, the voice chat service may be ad supported. Moreover, because a certain degree of information may be known about each invitee (i.e., location, age, line of business, gender, etc.), the ads may be customized for each invitee based on the known demographic information. The ads may also be interactive. For example, in one embodiment, the invitee is able to indicate whether he or she wishes to opt-in to hear additional information corresponding to the advertisement (block 118).

At block 120, the voice chat is established among all the individuals who accepted their respective invitations to join the voice chat. Because the voice chat is initiated by a service, it does not suffer from the degradation of signal quality associated with a 3-way call initiated from a landline or a cellular telephone.

Once the voice chat has been established, embodiments provide for several enhanced features. For example, the service may execute a roll call feature that identifies all the participants (block 122). The service may also maintain a log of the voice chat (block 124). The information in the log may include, but is not limited to, the number of individuals invited, the number of invitations accepted, the duration of the voice chat, the location of the participants, the demographics of the participants, and a listing of ads played during the voice chat. In one embodiment, the service may record and/or transcribe the voice chat (blocks 126, 144).

In one embodiment, the organizer, or another participant for that matter, is able to execute a control command during the voice chat (blocks 128, 130). For example, a participant may wish to mute one or more of the other participants. Similarly, one or more of the participants may choose to participate in a listen-only mode. The organizer may also choose to remove one or more participants, either before the voice chat is established or during the voice chat. Moreover, the organizer may also execute a command that prioritizes the other participants in the order that the organizer would like them to speak during the voice chat. The control commands may also include, but are not limited to, recording the voice chat, transcribing the voice chat, playing an audio clip during the call, which could be a pre-recorded message, a dynamically generated sound bite or even music, sending or receiving a text message, or sending or receiving information via WAP-push. In one embodiment, the pre-recorded message itself may be recorded via the voice-chat service calling the originator, and having the originator speak and hence recording the spoken message fro playback during the voice-chat. In another embodiment, the pre-recorded message itself may be generated automatically by transforming a text message that the originator sends to the service into voice via text-to-voice conversion mechanisms. The text message itself that the originator sends to the service may be received via email or via SMS text messaging. In one embodiment, a participant may also invite a new participant “on-the-fly” during a voice chat that is already established. This may be achieved from within the voice chat, or it may be achieved external to the voice chat (i.e., text message, e-mail, etc.). If the service detects that a participant has indicated that a new participant is to be invited (block 128), the service invites/adds the new participant to the voice chat (block 130).

In one embodiment, the service determines which participants opted in to hear additional information corresponding to the earlier played advertisement (block 136). At block 138, the additional information is provided to the users that opted in. A determination is made in block 140 as to whether a particular time has elapsed. The specified time is a configurable parameter which determines the duration of the call. This parameter could be based on a variety of factors, including but not limited to the advertisement value, etc. In one embodiment, the time is set at thirty minutes. If The time has elapsed, then block 142 prompts a voice message to indicate that the call limit has been reached. A new call will have to be initiated to continue the chat, block 144. A voice ad is then played in block 146 and the process proceeds to block 150. If the time has not elapsed, decision block 148 determines if there is at least one participant on the call. If there is at least one participant on the call, the process proceeds to block 150. Otherwise, if there are no participants on the call, the process proceeds to block 150. At block 150, the voice chat terminates. Upon the termination of the voice chat, the servers may then transcribe the voice chat (based on the recording, for example) as shown in block 152. The service may then provide the recording and/or transcription for the participants (blocks 154, 156). In one embodiment, the recording of the voice chat is provided in a format capable of being streamed over a network.

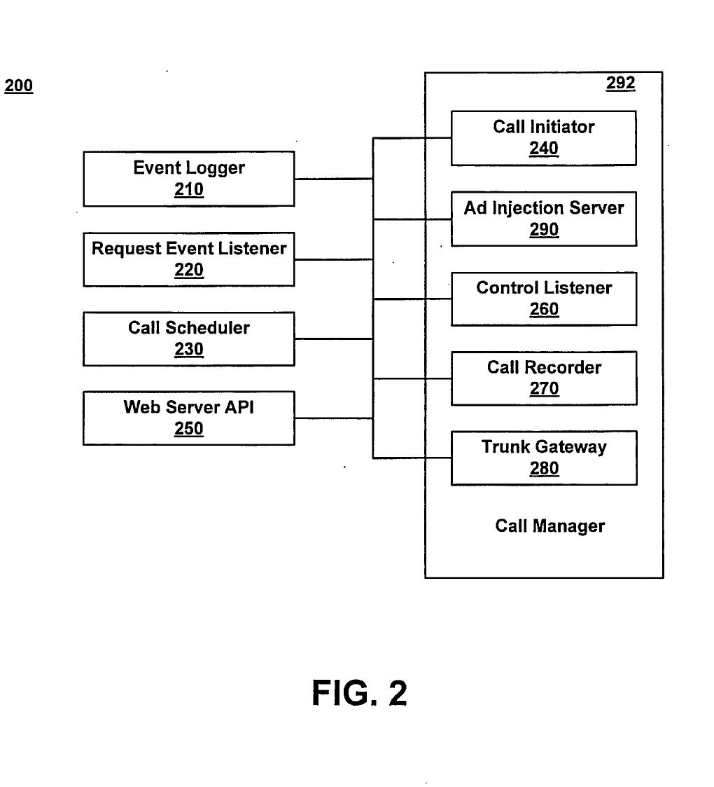

FIG. 2 illustrates a block diagram of a system 200 for initiating a voice chat, in accordance with various embodiments the present invention. System 200 includes a request event listener 220 for accepting information that identifies one or more individuals to invite to participate in a voice chat. This information may be received in a number of different ways. For example, the information may be included in a text message sent via a mobile telephone. The information may be included with an email message. The information may be submitted via a voice call. The information may also be submitted via a web page and then received via the web server API 250, for example. In one embodiment, the web page is accessible via a mobile telephone. In addition, the information identifying the individuals may take on a number of different forms. For example, with respect to a particular individual, the information may simply include the individual's phone number (landline, cellular, or otherwise). In another embodiment, the information includes an alias unique to the individual that effectively screens the organizer from knowing the individual's actual phone number. In the cases where individuals are identified by aliases, the request event listener 220 is operable to determine the phone number associated with the alias. For example, the event listener 220 may contact a phone alias service via the application interface API 250.

System 200 may also include a call scheduler 230. Call scheduler 230 effectively serves as a queue for the requests received by the request event listener 220. In one embodiment, voice chats can be scheduled for a specific date and time in the future. Thus, in such case, the call scheduler 230 is operable to resolve the locations of all invitees. This information is important because the call scheduler 230 may then select the preferred providers/gateways to initiate the calls through based on availability, pricing, etc. At the appropriate time, the call scheduler 230 directs a call initiator 240 to initiate the calls. The call scheduler 230 may also be operable to send an acknowledgment back to the organizer and also send a reminder to the other participants. Once again the acknowledgement/reminder message may be sent via SMS text message, email, voice call reminder, etc.

System 200 also includes the call initiator 240 mentioned above. The call initiator 240 is operable to establish the voice chat among the various invitees. In one embodiment, the call initiator 240 establishes the eventual connections to the participants via a trunk gateway 280. In one embodiment, the trunk gateway 280 is operable to establish the appropriate connections with the desired providers as determined by the call scheduler 230. Once an invitee has been called, the call initiator 240 is operable to determine whether the invitee has accepted the invitation for the voice chat.

The preferred providers/gateways over which the voice calls are initiated could be based on any number of technologies, including, but not limited to, ss7 signaling networks for telecommunications operators, voice networks for mobile operators including gsm, cdma, and ip networks, as well as voice over ip networks, In addition, the trunking mechanism used to establish voice connection between the service and the called parties may follow several protocols including but not limited to sip, iax.

In one embodiment, system 200 also includes an ad injection server 290. The ad injection server 290 is operable to play an advertisement for an individual who has accepted the invitation for the voice chat. In one embodiment, the advertisement is tailored to specific individual. For example, information regarding the individual's location (which itself may be a zip-code, a city, a state, country, a region, an area code etc) may be determined based on the individual's phone number. If, for example, system 200 is providing a service for a corporate client, the ads may be tailored to the client specific line of business. Furthermore, in the case of an individual that has signed up for a phone alias, demographic information which may include age and gender may be obtained from the phone alias server via the web server API 250. In case of an individual, the interests of the individuals (including their professional and personal interests) may be used to determine what ad to play. As described above, the ads played by the ad injection server 290 may be interactive. For example, a participant may be able to opt-in to hear additional information regarding the ad at the end of the voice chat. If a participant has indicated so, then the ad injection server 290 is operable to provide the additional information at the end of the voice chat.

In one embodiment, system 200 includes a control listener 260, which, once the call initiator 240 has established the voice chat, is operable to listen for control commands submitted by the participants during the voice chat and implement corresponding functions. For example, a participant may wish to mute one or more of the other participants. Similarly, one or more of the participants may choose to participate in a listen-only mode. The organizer may also choose to remove one or more participants, either before the voice chat is established or during the voice chat. Moreover, the organizer may also execute a command that prioritizes the other participants in the order that the organizer would like them to speak during the voice chat. The control actions may also include, but are not limited to, recording the call, transcribing the call, playing an audio clip which could be a pre-recorded message, a dynamically generated message or even music, sending or receiving a text message, or sending or receiving information via WAP-push. In one embodiment, a participant may also invite a new participant “on-the-fly” during a voice chat this argument established.

System 200 may also include a call recorder 270 for creating an audio recording of the voice chat. Upon completion of the voice chat to call recorder 270 may be operable to perform a number of functions. For example, the call recorder 270 may provide the recording to the participants. In one embodiment, this may be achieved by providing the recording in a format that is capable of being streamed over a network. The call recorder 270 may also be operable to transcribe the recording and provide the transcription to the participants.

System 200 may also include an event logger 210 for storing information pertinent to the voice chat. The information in the log may include but is not limited to, the number of individuals invited, the number of invitations accepted, the duration of the voice chat, the location of the participants, the demographics of the participants, and a listing of ads played during the voice chat. Upon conclusion of the voice chat, the event log may be made available to originator and the other participants as well, if desired. In one embodiment, the log is web-accessible via the web server API 250. The combination of the call initiator 240, ad injection server 290, control listener 260, call recorder 270, and trunk gateway 280 comprise a call manager 292.

System 200 may also include integration with any other service such as a mobile invitation service, a mobile publishing and viewing service, a mobile search service. Some examples of such integration include the ability to view someone's published content via a phone and from there be able to initiate a voice chat with that person, the ability to view an invitation to a mobile event and from there being to initiate a voice chat with some or all participants in the event, and the ability to initiate a voice chat with all the people whose names appeared as a result of a people search, and the ability to initiate a voice chat with a business or businesses which matched a business search criterion.

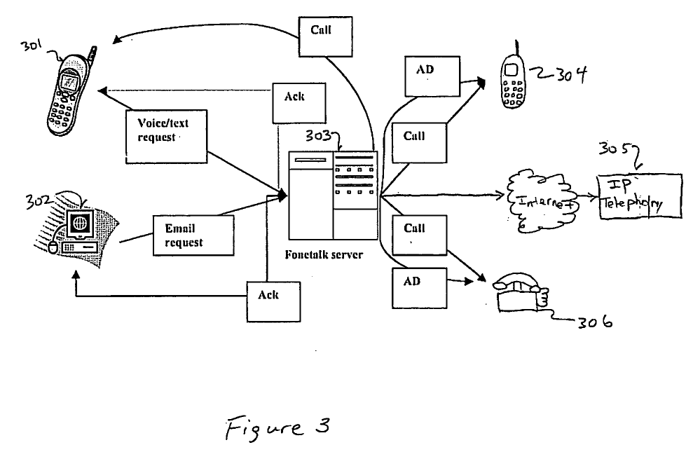

FIG. 3 shows a flow diagram of one embodiment of the present invention for initiating a multi-party teleconference. A person can initiate the teleconference through a voice or text request either through his/her phone 301 or by means of a computer system 302 (e.g., via email). The request is sent to a Fonetalk server 303. The request contains information related to the teleconference, such as participants' telephone numbers and/or aliases, the subject of the call, the time to schedule the call, etc. The Fonetalk server 303 can optionally send an acknowledgment back to the initiator once the teleconference has been set up. At the requested time, the Fonetalk server 303 initiates calls simultaneously to the specified participants as well as to the initiator. Optionally, the initiator need not be included in the conference call. The participants can be called wirelessly on their cell phone 304, over the internet on IP telephony 305, or over a standard wired POTS telephone 306. Any number of participants can be called concurrently to participate in the conference call. In one embodiment, when a participant answers the call, an advertisement is played. The Fonetalk server then invites the participant to join in the teleconference. At this point, the participant can choose to accept the invitation and join in the teleconference by pressing a selected key. Note that there is no need to enter in a password because only those participants designated by the original initiator will get called with invitations to join the teleconference. In addition, the participants do not need to enter any special account number to identify the teleconference session. The participants' acceptances and/or rejections are sent back to the Fonetalk server 303. Only those participants who elected to accept the invitation are allowed to join the teleconference. Thereupon, the Fonetalk server 303 initiates the actual teleconference and all those participants who joined can communicate in full duplex amongst themselves.

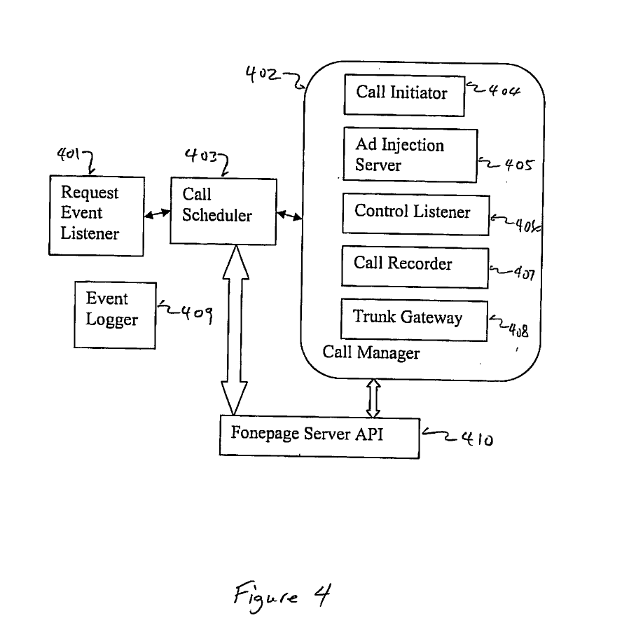

FIG. 4 shows a detailed diagram for a teleconferencing system whereby the call manager calls the designated participants and invites them to join the teleconference. The teleconferencing is initiated by a Request Event Listener 401. The Request Event Listener 401 listens for call initiation events generated from various interfaces. Events can come from Fonemine Web UI, WAP UI, or end users' text messages. The job of the Request Event Listener 401 is to unify the requests from different interfaces to an internal request to the Call Manager 402 to initiate a conference at real time without delay. The Call Scheduler 403 receives conference schedule requests from Fonemine Web and WAP UI and saves the schedule data into persistent storage. It periodically wakes up based on the scheduled data and passes on the requests to the Call Manager 402 to initiate the call at the specified time. The Call Manager 402 includes a Call Initiator 404, Ad Injection Server 405, Control Listener 406, Call Recorder 407, and Trunk Gateway 408. Event Logger 409 stores information relating to the calls. And the Fonepager Server API 410 facilitates the Call Scheduler 403 and Call Manager 402.

Thus, embodiments provide technology for service-initiated phone calls. As stated above, the calls are not necessarily limited to conference calls. The service-initiated call may be for any number of participants, including one. For example, a single person may use the service to set up a call reminder or a call alarm. Moreover, the service-initiated calls may be originator driven (i.e., “push”) or they may be participant driven (i.e., “pull”). For example, one individual may access a personal phone page of another that provides a link to a song. The individual accessing the page may activate a function on the page that causes a service-initiated call to him or her. Then, when he or she answers, the service may play the song. In another context, the service may play an audio recording of a lecture or some message that was pre-recorded, for example.

Because the calls are service-initiated, rather than originator-initiated, a layer of anonymity can be provided for the originator and that the originator's phone number is not known to the other invitees. Moreover, the originator has complete control over who the participants are, because the originator specifies them and only those individuals specified are called. The originator can also delegate control to specific participants!

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of initiating a voice chat comprising:
accepting information identifying one or more individuals to invite to participate in the voice chat;
initiating calls to the one or more individuals to invite the individuals to join the voice chat; and
establishing the voice chat amongst all individuals who accept their respective invitations to join in the voice chat.

2. The method of claim 1, wherein the calls to invite the one or more individuals to join the voice chat are initiated by a server.

3. The method of claim 1, wherein an originator specifies the one or more individuals to participate in the voice chat and only those individuals specified by the originator are invited to participate in the voice chat.

4. The method of claim 1 further comprising displaying a phone number corresponding to an individual who originated the voice chat.

5. The method of claim 1 further comprising displaying a phone number corresponding to an service number.

6. The method of claim 1, wherein the one or more individuals are identified through respective phone numbers.

7. The method of claim 1, wherein the one or more individuals are identified through one or more aliases, wherein the aliases provide a layer of anonymity for corresponding telephone numbers.

8. The method of claim 1, wherein the information identifying the one or more individuals to invite to participate in the voice chat comprises a voice call.

9. The method of claim 1, wherein the information identifying the plurality one or more individuals to invite to participate in the voice chat comprises an email message.

10. The method of claim 1, wherein the information identifying the one or more individuals to invite to participate in the voice chat comprises a text message.

11. The method of claim 1 further comprising:
sending a reminder to an individual invited to participate in the voice chat.

12. The method of claim 10, wherein the reminder comprises a text message.

13. The method of claim 10, wherein the reminder comprises a voice message that was initiated via a voice chat service.

14. The method of claim 1 further comprising:
playing an advertisement when an individual joins the voice chat.

15. The method of claim 13, wherein the advertisement is personalized to the individual based on the individual's location, demographics, and interests.

16. The method of claim 13 further comprising:
enabling the individual to opt-in to hear additional information corresponding to the advertisement, wherein the additional information conveyed for the individual subsequent to the voice chat in the form of email, text message, or voice call.

17. The method of claim 1, wherein at least four individuals can talk and hear simultaneously during the voice chat.

18. The method of claim 1, wherein at least one of the one or more individuals is calling from a wireless device and the voice chat amongst a plurality of participants is conducted with no loss in wireless signal strength.

19. The method of claim 1, wherein the voice chat is originator driven.

20. The method of claim 1, wherein the voice chat is participant driven.

21. The method of claim 1 further comprising:
enabling an individual invited to participate in the voice chat an opportunity to accept or reject joining the voice chat.

22. The method of claim 1 further comprising:
initiating calls to the one or more individuals to invite the one or more individuals to join the voice chat at a pre-determined, scheduled time.

23. The method of claim 1 further comprising:
recording the voice chat; and
providing the recording of the voice chat to one or more participants in the voice chat.

24. The method of claim 23 wherein the voice chat is recorded in a format capable of being streamed over a network.

25. The method of claim 1 further comprising:
enabling a new participant to be invited to join the established voice chat.

26. The method of claim 1 further comprising:
enabling an organizer to invoke a control command in the established voice chat, wherein the control command is selected from the group consisting of muting the organizer, muting a particular participant, recording the call, playing an audio clip which can be a pre-recorded message or a song, sending or receiving a text message, sending or receiving information via WAP-push, and removing a particular participant.

27. The method of claim 1 further comprising:
enabling an organizer to remove a participant prior to or during the voice chat being established.

28. The method of claim 1 further comprising:
transcribing the voice chat; and
providing the transcription of the voice chat to one or more participants in the voice chat.

29. The method of claim 1 further comprising:
providing the one or more individuals with an option for a listen-only mode.

30. The method of claim 1 further comprising:
enabling an organizer to prioritize other participants in the order of when they are allowed to speak during the voice chat.

31. The method of claim 1 further comprising:
conducting a roll call to identify all the participants.

32. The method of claim 1 further comprising:
creating a voice chat log that contains information selected from the group consisting of the number of individuals invited, the number of invitations accepted, voice chat duration, location of participants, demographics of participants, and a listing of ads played during the voice chat.

33. A system for initiating a voice chat, comprising:
a call listener for accepting information identifying one or more individuals to invite to participate in the voice chat;
a call initiator for initiating calls to the one or more individuals to invite the individuals to join the voice chat, wherein the call initiator is operable to establish the voice chat amongst all individuals who accept to their respective invitations to join in the voice chat.

34. The system of claim 33 wherein the information identifying the one or more individuals includes a specified time for conducting the voice chat, the system further comprising:
a call scheduler for causing the call initiator to initiate the calls to the one or more individuals at the specified time.

35. The system of claim 33 further comprising:
an event logger for creating a voice chat log that contains information selected from the group consisting of the number of individuals invited, the number of invitations accepted, voice chat duration, location of participants, demographics of participants, and a listing of ads played during the voice chat.

36. The system of claim 33 further comprising:
a web server interface for communicatively coupling the system with one or more web servers.

37. The system of claim 33 further comprising:
an ad server for playing an advertisement when an individual joins the voice chat.

38. The system of claim 33 further comprising:
a control listener for listening for a control command and performing a function corresponding to the control command, wherein the control command is selected from the group consisting of: muting an organizer, muting a particular participant, recording the call, playing an audio clip, sending or receiving a text message, sending or receiving information via WAP-push, and removing a particular participant.

39. The system of claim 33 further comprising:
a call recorder for recording the voice chat and providing the recording to one or more participants.

40. The system of claim 39 wherein the recording is provided in a form capable of being streamed over a network.

41. The system of claim 39 wherein the call recorder is operable to transcribe the voice chat and provide a transcription to one or more participants.

42. The system of claim 33 further comprising:
a trunk gateway for establishing connections between the system and telephone service providers corresponding to the one or more individuals.

43. A system for initiating a voice chat, comprising:
means for accepting information identifying one or more individuals to invite to participate in the voice chat;
means for initiating calls to the one or more individuals to invite the individuals to join the voice chat; and
means for establishing the voice chat amongst all individuals who accept their respective invitations to join in the voice chat.

44. The system of claim 43 further comprising:
means for sending a reminder to an individual invited to participate in the voice chat.

45. The system of claim 43 further comprising:
means for playing an advertisement when an individual joins the voice chat.

46. The system of claim 45 further comprising:
means for enabling the individual to opt-in to hear additional information corresponding to the advertisement; and
means for providing the additional information for the individual subsequent to the voice chat.

47. The system of claim 43 further comprising:
means for enabling an individual invited to participate in the voice chat an opportunity to accept or reject joining the voice chat.

48. The system of claim 43 further comprising:
means for initiating calls to the one or more individuals to invite the one or more individuals to join the voice chat at a pre-determined, scheduled time.

49. The system of claim 43 further comprising:
means for recording the voice chat; and
means for providing the recording of the voice chat to one or more participants in the voice chat.

50. The system of claim 43 further comprising:
means for transcribing the voice chat; and
means for providing a transcription of the voice chat to one or more participants in the voice chat.

51. The system of claim 43 further comprising:
means for enabling a new participant to be invited to join the established voice chat.

52. The system of claim 43 further comprising:
means for enabling a participant to invoke a control command, wherein the control command is selected from the group consisting of muting an organizer, muting a particular participant, recording the call, playing an audio clip, sending or receiving a text message, sending or receiving information via WAP-push, and removing a particular participant.

53. The system of claim 43 further comprising:
means for creating a voice chat log that contains information selected from the group consisting of the number of individuals invited, the number of invitations accepted, voice chat duration, location of participants, demographics of participants, and a listing of ads played during the voice chat.
